(19) United States
(12) Patent Application Publication
(10) Pub. No.: US 2007/0201375 A1
(43) Pub. Date: Aug. 30, 2007

(54) Method and apparatus for provisioning a network

(76) Inventors: Paul M. Hallinan, San Carlos, CA (US); Man-Tung T. Hsiao, Cupertino, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/363,515

(22) Filed: Feb. 24, 2006

(51) Int. Cl. H04J 1/16

(52) U.S. Cl. 370/252; 370/392

(57) ABSTRACT

A method or corresponding apparatus provisions a network to support “open bandwidth” (openBW) Label Switched Paths (LSPs) that are define by a zero (0 Mbps) or substantially small bandwidth and enabled to burst up to a line rate of a communications path across which the LSP traverses.

### BACKGROUND OF THE INVENTION

Communications networks, such as optical communications networks, may use routers provisioned to carry network communications according to service plans between a service provider and a customer. For example, a customer may have a high cost service plan with the service provider that ensures their network communications are transmitted through the network at a guaranteed rate. Lower cost service plans may allow the service provider to carry the communications at a less than optimal rate depending upon congestion of the network.

In an optical communications network, an optical path, such as a fiber optic communications link, may be set-up as a communications trunk, carrying communications at optical rates, such as OC-192 (10 Gbps) or OC-48 (2.488 Gbps) rates. A service provider may employ Multi-Protocol Label Switching (MPLS) and configure Label Switched Paths (LSPs) on the optical links or trunks. LSPs are said to traverse the optical links or trunks, and logical circuits, with which some network traffic is associated, are said to ride on the LSPs. To set-up the LSPs and circuits, the network service providers may provision their network through use of configuration and management processes. These processes may include setting-up routers along the optical links in a given state to support the LSPs passing through the routers along the links.

### SUMMARY OF THE INVENTION

A method or corresponding apparatus according to an embodiment of the present invention may be used to provision a network. The method or corresponding apparatus may include signaling a router that a given Label Switched Path (LSP) is to use zero bandwidth (BW) and to be allowed to burst up to a line rate of a trunk across which the LSP traverses. This form of LSP is referred to herein as an open bandwidth (openBW) LSP.

In another embodiment, a first subset of LSPs may be provisioned as traditional, bandwidth configured LSPs, also referred to herein as Quality of Service (QoS) LSPs, and a second subset of the LSPs may be provisioned to be openBW LSPs, where, again, the openBW LSPs are provisioned with zero bandwidth and allowed to burst up to a line rate of a communications path on which the openBW LSPs traverse.

Through use of embodiments of the present invention, the service provider may offer bandwidth configured LSP service on a network and offer openBW LSP service on the same network.

### BRIEF DESCRIPTION OF THE DRAWINGS

The foregoing and other features and advantages of the invention will be apparent from the following more particular description of example embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a network diagram in which a method of provisioning a network is employed;

FIG. 2 is a network diagram in which an example embodiment of the present invention is employed to provision Label Switched Paths (LSPs) on the network;

FIG. 3A is a network diagram illustrating details of an example embodiment of the present invention;

FIG. 3B is a network diagram illustrating aspects of an example embodiment of the present invention;

FIG. 4 is a network diagram illustrating a fast reroute technique made available through use of an example embodiment of the present invention; and

FIGS. 5-9 are flow diagrams illustrating example embodiments of operation of the present invention.

### DETAILED DESCRIPTION OF THE INVENTION

A description of example embodiments of the invention follows.

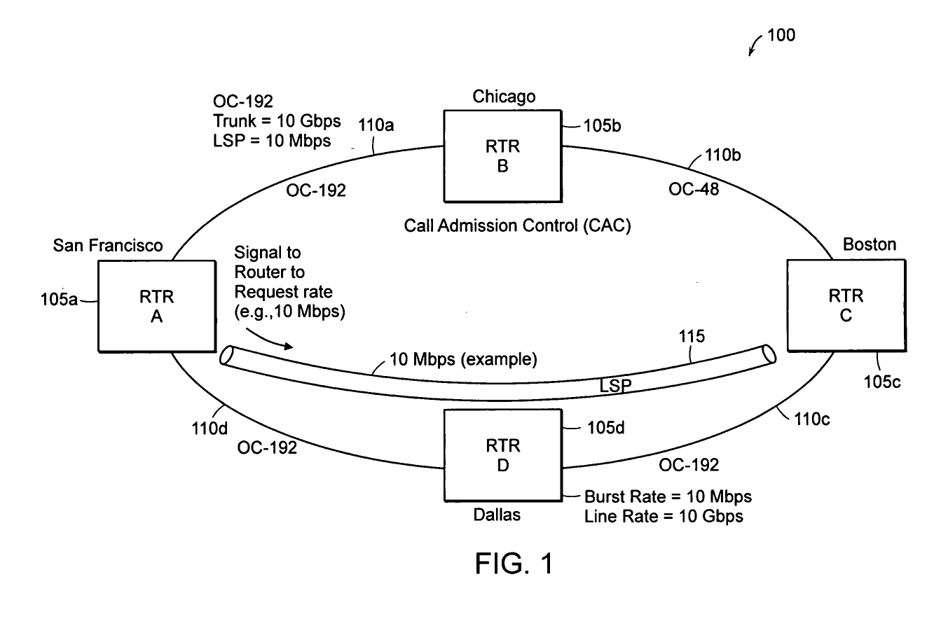

FIG. 1 is a network diagram of an example optical network 100 that includes four nodes: router A 105a, router B 105b, router C 105c, and router D 105d (collectively, routers 105a . . . d). Between the routers 105a . . . d are fiber optic links 110a . . . d. As illustrated, three fiber optic links 110a, 110e, and 110d are configured to support OC-192, and the fourth fiber optic link 110b is configured to support OC-48. An OC-192 fiber optic link can support a data rate of 10 Gbps, and an OC-48 fiber optic link can support a data rate of 2.488 Gbps. Other data rates, such as 40 Gbps, may also be supported on the fiber optic links 110a . . . d.

Any of the fiber optic links 110a . . . d may be referred to as a “trunk.” Using Multi-Protocol Label Switching (MPLS), each trunk may be configured to support communications. MPLS communications paths may be configured to support MPLS transport “tunnels,” where each of the tunnels may be referred to as a Label Switched Path (LSP), or simply an “LSP.”

Continuing to refer to FIG. 1, an LSP 115 is illustrated as being configured between router A 105a and router C 105c by traversing fiber links 110d and 110c via router D 105d. There can be many LSPs on a single fiber link, so each is given a limited bandwidth. Each of these LSPs is referred to herein as a “bandwidth configured” LSP. For example, the LSP 115 may be configured to support 10 Mbps, where configuring or provisioning (used herein synonymously) the LSP 115 may be done by signaling to the routers along the route, router A 105a, router D 105d, and router C 105c, to allow the LSP 115 to support communications up to the specified rate.

A Call Admission Control (CAC) protocol may be employed in each of the routers 105a . . . d to prevent the LSPs 115 associated with a given network node from exceeding a specified rate, such as a burst rate of 10 Mbps (for one LSP) or a line rate of 10 Gbps (across all LSPs). In operation, this means that when the LSP 115 is being signaled (i.e., configured through each of the routers 105a, 105d, 105c along its network path 110d and 110c), the CAC protocol determines whether the LSP 115 is allowed to be built based on parameters provisioned in each of the routers. For example, if the LSP 115 is requesting a burst rate of 50 Mbps but the allowed maximum burst rate is set at 10 Mbps, the CAC protocol denies provisioning of the LSP 115. In such a case, the LSP 115 may have to be provisioned on a different optical path, such as an optical path along an optical fiber that has been provisioned to support 50 Mbps via the same network nodes or along different network nodes, such as from routers A to C through router B 105b. The CAC protocol may also (i) sum (a) rates of all currently provisioned LSPs and (b) a rate of a requested LSP and (ii) deny provisioning if the total rate exceeds the rate supported by the trunk. Once an LSP is provisioned, a shaper (not shown) within each of the routers prevents the LSP 115 from exceeding the provisioned data rate.

As understood in the art of MPLS, a guaranteed rate LSP, one form of bandwidth configured LSP, is designed to allow a customer to pass its data through the network at a predetermined rate, whereas non-guaranteed rate LSPs, another form of bandwidth configured LSP, optionally configured using a Resource ReserVation Protocol (RSVP), may not support traffic at a predetermined rate, such as in a case where there is congestion in the network 100 or in a particular router 105a . . . d. A bandwidth configured LSP 115 can be provisioned to be either a guaranteed rate LSP or a non-guaranteed rate LSP. In existing systems, LSPs of different types are not allowed to be configured in the same optical fiber.

A problem with typical MPLS configured networks is the amount of configuration required to have the network operate. What is needed is a way to simplify the configuration process.

An embodiment of the present invention provides a customer with a simpler way to manage bandwidth in a network, such as a multi-point network. In general terms, an example embodiment of the present invention simplifies configuration for managing bandwidth by signaling an LSP with a committed rate set to zero and a burst rate up to the line rate. This type of LSP is referred to as an open bandwidth (openBW) LSP, and an unlimited number of openBW LSPs can be provisioned on a network path without the user having to configure each node on the network path to support each LSP as in the case of bandwidth configured LSPs, a process that is typically very time consuming. Details and other embodiments are described hereinbelow.

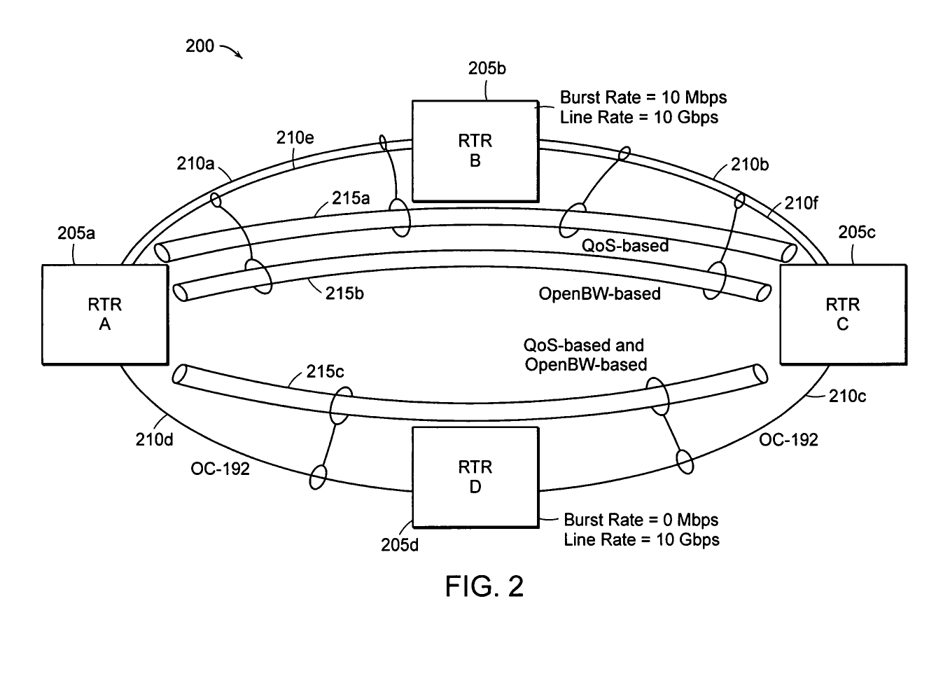

FIG. 2 is a network diagram of a network 200 employing an embodiment of the principles of the present invention. The network 200 includes four routers: router A 205a, router B 205b, router C 205c, and router D 205d. Between these routers 205a . . . d are optical fiber links 210a . . . d. Signaling techniques using MPLS may be used to set-up LSPs between the routers 205a . . . d, also referred to herein as network nodes or just “nodes.” In the example network of FIG. 2, there are three LSPs 215a, 215b, and 215c that span between router A 205a and router C 205c. A first LSP 215a is provisioned to traverse a network path defined by optical fibers 210a and 210b. A second LSP 215b is provisioned to traverse a second network path defined by optical fibers 210e and 210f via router B 205b. A third LSP 215c is provisioned to traverse a network path defined by optical fibers 210c and 210d and router D 205d.

In this example configuration, the first LSP 215a is a bandwidth configured LSP, and the second LSP 215b is provisioned as an openBW LSP. A bandwidth configured LSP is interchangeably referred to herein as a Quality of Service (QoS) LSP.

Continuing to refer to FIG. 2, in one embodiment, a bandwidth configured LSP 215a and an openBW LSP 215b are provisioned to traverse separate optical fibers 210a/b and 210e/f, respectively. Employing another embodiment of the present invention, the third LSP 215c is provisioned to support both bandwidth configured (QoS) and openBW LSPs 215c and traverses a single fiber 210c/d between any two

The way in which the network is provisioned to have a LSP supporting multiple protocols is done in the following manner. Customers preferably build their network to support more traffic bandwidth than is needed over a given network link (e.g., optical fibers 210c and 210d). This allows extra bandwidth for handling openBW LSPs should burst rates exceed typically provisioned burst rates (e.g., 10 Mbps), where the openBW LSPs are allowed to reach the line rate (e.g., OC-192, 10 Gbps) or substantially reach the line rate (e.g., 8-10 Gbps). The network nodes 205a . . . d are signaled to provision an openBW LSP to use zero Mbps so the openBW LSP passes CAC, thus allowing as many openBW LSPs as desired on a given fiber link.

Customers using traditional LSP provisioning techniques have a large amount of configuring to do (e.g., configuring network links to support LSPs with multiple rates). However, because the openBW LSPs are signaled at zero Mbps, the provisioning passes all CAC tests through the path on which the LSP is provisioned. Therefore, openBW LSPs succeed in being built according to an embodiment of the present invention. Each openBW LSP is allowed to burst up to the line rate by configuring a shaper, which is typically a hardware element (not shown) in the routers, to allow the burst rate to extend, optionally, all the way up to the line rate. It should be understood that the burst rate signaled to provision the LSPs may be zero Mbps or may be a sufficiently small number such that the CAC tests are passed during the provisioning process.

There are presently four traffic classes of LSP under the RSVP protocol of MLPS, limited by the three bits in the MPLS EXP header in certain versions of MPLS. The order from highest priority to lowest priority is as follows: (i) Constant Bit Rate (CBR) LSP, (ii) Variable bit rate, Real-Time (VBRrt) LSP, (iii) Variable Bit Rate, Non-Real-Time (VBRnrt) LSP, and (iv) Unspecified Bit Rate (UBR) LSP, which is a “best effort delivery” LSP.

A guaranteed bit rate LSP is an example of a configured bandwidth/QoS LSP and refers to a CBR LSP or a VBRrt LSP, and a non-guaranteed bit rate/openBW LSP refers to a VBRrt, VBRnrt, or UBR LSP. Non-guaranteed bit rate LSPs also are examples of openBW LSPs, which only guarantee burst rates up to about the line rate if there is bandwidth availability on the communications link(s) on which the openBW LSP traverses. The different classes allow a network service provider to offer data rates to their customers at different cost structures according to the priority level associated with each of the LSPs. For example, a corporate customer may have to pay a significantly higher price to have its data traffic carried on a CBR LSP, as opposed to a UBR LSP. Through use of an embodiment as described in reference to FIG. 2, a single LSP can be configured to support all four traffic classes on a single LSP. For example, the third LSP 215c can be provisioned to carry Constant Bit Rate (CBR) traffic over optical fibers 210c, 210d, and an openBW LSP can be provisioned to carry Variable Bit Rate, non-real-time (VBRnrt) traffic over the same optical fibers 210c, 210d.

According to an embodiment of the present invention, in the course of provisioning a network, the embodiment provisions an LSP to be an openBW LSP by signaling to routers or other network nodes along a network path that an LSP is to use zero bandwidth (i.e., zero data rate), or substantially less than an amount of bandwidth normally used to carry circuits on an LSP, and to allow the LSP to burst up to a line rate or substantially up to the line rate of a trunk across which the LSP traverses. Because the LSP is specified as using zero or a substantially small bandwidth, the CAC protocol in the network nodes supporting the LSP allows the LSP to be provisioned regardless of how many other LSPs the network nodes are already supporting or how many other LSPs are already traversing the same network communications trunk.

An LSP on the network may be provisioned to be a Quality of Service (QoS) LSP. In one embodiment, the QoS LSP may be provisioned based on a user-specified rate, and, for the openBW LSP, the shaper is set to allow bursts up to a line rate. As understood in the art, the shapers may be in the form of queues that allow bursts of network traffic that are output over time. Policers or other similar network elements may continue to be configured to drop non-conforming traffic.

Users of embodiments of the present invention may create multiple logical overlay networks that allow openBW and bandwidth configured/QoS LSPs to coexist. In one embodiment, network paths, LSPs, and circuits may have “colors” associated with them, where the colors may be taken into account when a network node determines which circuits ride on which LSPs and which LSPs can traverse which network paths. In one embodiment, the circuits may be defined as “Martini” circuits, which define a way of transporting Layer 2 traffic across an LSP, and a user or network provider may be allowed to create preferences as to whether the circuits ride on a QoS LSP or an openBW LSP. The colors may be employed when creating the preferences and the network nodes may enforce these preferences based on the colors.

In another embodiment, a network may include multiple routers, trunks interconnecting the multiple routers, and LSPs traversing the trunks. In this embodiment, a first subset of the LSPs may use a QoS model and a second subset of the LSPs may use an openBW model.

The network may further include multiple overlay networks, optionally facilitated by a customer, and allow the customer to have QoS and openBW LSPs to coexist without interfering with each other. The network may also include trunks configured to support LSPs of QoS models, openBW models, or a combination of each. The LSPs may be assigned a color, based on a user configuration, and the trunks may be assigned a color based on the user configuration. The network may also include a router that supports constraint-based routing of LSPs to constrain assignment of LSPs to trunks as a function of their assigned colors.

The network may further include circuits that have been assigned colors and may allow a user to configure the LSPs to include or exclude circuits of selected colors. The circuits may be constrained to LSPs based on their colors, and the LSPs may be constrained to trunks based on their colors.

Moreover, based on various embodiments of the present invention, a service provider, corporate entity, or other entity in control of a network, may offer network services to customers in the following manner. First, the entity offering the services may offer QoS service on the network. Second, the entity may offer openBW services on the same network. Because the network can support both types of services, there are more options available for users of the network, and certain advantages can be gained through subscription to a network in which both QoS and openBW services are provided, such as Fast ReRoute (FRR) capability.

Ordinary RSVP LSPs, where the user specifies the rate of the LSP, has posed provisioning problems in existing systems for Virtual Private LAN Service (VPLS) and Virtual Private Networks (VPN) services. In one embodiment, the present invention employs an unlimited bandwidth Resource ReSerVation Protocol Traffic Extension (RSVP-TE) solution. In this example approach, RSVP-TE LSPs are created with no limits on the bandwidth of the LSP. There may be no limits for each class of the LSP, including a Constant Bit Rate (CBR) class. A parameter on each LSP can be used to control whether it is of unlimited bandwidth. On these LSPs, egress marking of packets may be disabled. The openBW LSPs may not be CAC'ed (i.e., subject to a call admission control process) because these LSPs are signaled as zero bandwidth, or other significantly low bandwidth, such as less than 10 or 100 Kbps, to nodes that are to support the LSPs. The LSP rate may only be limited by its outgoing port speed, in some embodiments.

This solution supports hard QoS LSPs (i.e., guaranteed bit rate LSPs at constant bit rate). A hard QoS LSP can be created and CAC'ed, accordingly. Guarantees on these LSPs may depend upon the amount of traffic on the unlimited bandwidth LSPs. If a customer intends to use a Variable Bit Rate real-time (VBRrt), Variable Bit Rate non-real-time (VBRnrt), and Unspecified Bit Rate (UBR) classes for unlimited bandwidth LSPs and not allow multi-point traffic on the CBR class of the LSP, then hard QoS LSPs can be created which can be used to guarantee bandwidth for deterministic services for the CBR class.

Embodiments of the present invention offer some or all of the following advantages to a service provider provisioning a network and its customers:
(i) no bandwidth has to be specified for unlimited bandwidth (i.e., openBW) RSVP-TE LSPs;
(ii) VPLS-PEs (i.e., devices at an edge of a service provider's network with functionality for VPLS) and Internet Protocol (IP) traffic protocols do not require bandwidth configuration, which reduces configuration effort for the customer;
(iii) supports soft QoS models (i.e., guaranteed bit rate LSP with VBRrt), and traffic may be sent in accordance with priorities;
(iv) egress markings of their packets may be disabled automatically;
(v) MPLS Fast ReRoute (FRR) and back-up paths for the LSPs may also be of unlimited bandwidth;
(vi) embodiments of the technique may not require the customer to configure any interface CAC oversubscription;
(vii) LSPs can continue to be traffic engineered, where traffic engineering constraints can be specified for these LSPs to accommodate link attributes, Multi-Tenant Unit (MTU) constraints, and path constraints, such as loose, strict, explicit, and so forth; and
(viii) example embodiments of the solution support hard QoS LSPs, and traffic on hard QoS LSPs (i.e., guaranteed bit rate LSPs with constant bit rate) can be guaranteed if traffic on unlimited bandwidth LSPs is kept at a lower priority.

Some caveats to be aware of are that the limits on CBR traffic class may not apply to unlimited bandwidth LSPs. Also, care is preferably taken on limiting an amount of data traffic on CBR class to avoid affecting controlled traffic.

OpenBW LSPs can provide a simpler way to manage bandwidth in a multi-point network for VPLS and VPN services. Ordinary RSVP LSPs, where the user specifies the rate of the LSP, poses provisioning problems for VPLS and VPN services. OpenBW LSPs, which are provisioned with zero bandwidth, may be CAC'ed and signaled with the committed rate set to zero, or other substantially low rate, and may be programmed with shapers set to the line rate. Characteristics of a network supporting openBW LSPs are as follows:
(i) each LSP is allowed to burst up to the line rate;
(ii) since the LSPs are not CAC'ed against the interface bandwidth, no bandwidth guarantees are provided;
(iii) LSP scheduling is based strictly on the traffic class. All traffic class 3 data (e.g., CBR LSPs and a CBR portion of e-LSPs (i.e., exponent-inferred LSPs) is serviced first, followed by traffic class 2 data (e.g., VBRrt L-LSPs (i.e., label-only-inferred LSP) and VBRrt portions of e-LSPs), and so forth;
(iv) when the sum of all the CBR traffic exceeds the line rate (e.g., OC-192 10 Gbps), none of the VBRrt, VBRnrt, and UBR data is forwarded. Similarly, when the sum of the CBR and VBRrt traffic classes exceeds the line rate, none of the VBRnrt, and UBR traffic is forwarded, and so forth; and
(v) within a given traffic class, LSPs are serviced in a round robin manner.

For example, if the sum of the CBR traffic exceeds the line rate, each CBR L-LSP may be scheduled equally on an outgoing interface.

As described above in reference to FIG. 2, embodiments of the present invention allow ordinary (i.e., bandwidth configured) and openBW LSPs to co-exist in the same node. However, since the openBW LSPs are not policed, placing openBW LSPs on the same interface as ordinary LSPs may degrade the quality of service (QoS) requirements of the ordinary LSPs. For this reason, the service provider may choose to separate the openBW LSPs from the ordinary LSPs based on link attributes, thereby essentially creating two overlay networks: one for the openBW LSPs and the other for ordinary LSPs.

To support Martini traffic over mixed networks, embodiments allow the user to specify a preference for openBW versus ordinary LSPs on a per circuit basis.

Two new Command Line Interface (CLI) commands may be used for provisioning an LSP type and one for a circuit preference. The user may specify the LSP type through the following CLI command:

enable config protocol mpls lsp name <name> [no] open-bw-lsp,

where the default value is “no open-bw-lsp.”

The user may specify the LSP preference for circuits through the following CLI command:

enable config ckt name x side id 1 lsp dynamic-ckt [no] prefer-open-bw-lsp, where the default value is “no prefer-open-bw-lsp.”

Since ordinary LSPs offer a greater assurance of QoS than openBW LSPs, ordinary LSPs may be the default LSP type unless the user specifies otherwise. This is a “preference” not a requirement, so if the preferred LSP type is not available and the other LSP type is available, the available LSP type may be set as the default.

A precedence of rules to find a best match LSP are as follows, where rule 1 has highest precedence:
1. dynamic-ckt preference [te|be|static|te-llsp|te-elsp|all]
2. dynamic-ckt [no] prefer-open-bw-lsp
3. dynamic-ckt [no] prefer-non-ip-en-lsp

The following example illustrates how the above rules may be applied. Assume all the LSPs meet the circuit qualification requirements (i.e., meet the circuit's service class, bandwidth, MTU, and attribute requirements, and assume the user provisions the circuit as follows:
enable config ckt name x side id 1 lsp dynamic-ckt preference static te
enable config ckt name x side id 1 lsp dynamic-ckt prefer-open-bw-lsp
enable config ckt name x side id 1 lsp dynamic-ckt prefer-non-ip-en-lsp
enable config global-options ckt fill-mode least-fill

If there is a qualifying static LSP, it is selected as the “dynamic-ckt preference” option and has the highest precedence. If there are no qualifying static LSPs but there is a qualifying openBW and non-openBW LSP, the openBW LSP is selected. If there are two openBW LSPs and one is IP-enabled while the other is non-IP-enabled, the non-IP-enabled LSP is selected. And, if there are more than one of these, the least-fill/most-fill preference may be used to determine the LSP to use.

Since the system may not maintain circuit CAC tables on openBW LSPs, the least-fill/most-fill setting may not apply. When multiple openBW LSPs exist to the same destination, circuits get evenly distributed over these LSPs.

OpenBW LSPs may be signaled as follows:
CBR:
   CDR=0
   PDR=0

For all other service classes:
CDR=0
PDR=0xffffffff (rsvp protocol uses 0xffffffff to indicate “use the line rate”)

Since the interface CAC is based on the LSP's CDR, the LSP passes the interface CAC at all the nodes along the path of the LSP (for nodes running software supporting such functionality).

As described above in reference to FIG. 2, openBW LSPs are built with the shapers set “wide open” so the LSP is allowed to burst up to the line rate.

In accordance with an embodiment of the present invention, all transmit and terminating RSVP LSPs are programmed with the shapers set wide open, and reliance is placed on the policing and shaping on as ingress path in a network node to the enforce QoS requirements. Thus, adding support for openBW LSPs does not require any changes in the way the policers and shapers are programmed at the transmit and terminating nodes.

To support Fast ReRoute (FRR) enabled openBW LSPs, a method may be employed to convey to downstream nodes that a given LSP is an openBW LSP, so the transmit nodes know to build openBW detours/bypasses. Two methods to convey this to downstream nodes may be as follows:
(i) add a signaling extension to indicate that the LSP is an openBW LSP
(ii) use the signaled CDR/PDR values to determine if this is an openBW LSP

The RSVP protocol allows adding vendor specific extensions by providing methods for the protocol software to “skip over” unknown Type, Length, and Value parameters (TLVs) in the signaling messages. However, adding signaling extensions can be problematic in that other vendors may not follow the standards to “skip over” unknown TLVs.

To avoid incompatibility issues, an embodiment of the present invention may use the CDR/PDR values to determine if an LSP is an openBW LSP. Fast reroute transmit and nodes look for the PDR/CDR values described above to determine if the protected path is an openBW LSP. If so, the transmit node creates an openBW bypass/detour.

New CLI commands may be provided as specified above in reference to FIG. 2. In some embodiments, for openBW LSPs, the CLI commands may not allow the user to provision the PDR or CDR traffic parameters; thus, such CLI commands may not allow “admin enable” or “active lsp update” if openBW is enabled and there is a non-zero PDR or CDR.

The following areas of an LSP manager operating in the network are provided to support the foregoing embodiments:
(i) circuit preferences are implemented as described above;
(ii) Customer Network Managers (CNMs) are configured to set the policing/shapers to 10 Gbps (or other line rate) for openBW LSPs
(iii) mplsCtrl is configured to signal the LSP with CDR=0, PDR=0xffffffff, as described above;
(iv) for Constrained Shortest Path First (CSPF) LSPs, specify CDR=0 when asking Traffic Engineering Manager (TEM) to find a path;
(v) for 1-1 fast reroute, if the protected path is openBW, make the detour openBW as well. This applies to both ingress and transmit nodes; and
(vi) when telling an Internet Control Message (ICM) manager about IP-enabled openBW LSPs, pass a flag to indicate that the shaper should be set to 10 Gbps (or other line rate).

In operation of one embodiment, the lspMgr tells the ICM about IPenabled LSPs. The ICM then notifies an Information Technology Manger (ITM) who then tells the CNM to program the Layer 3 connection. A flag is passed from the lspMgr to the ICM then to the ITM so the ITM knows to tell the CNM to set the shaper to 10 G (or other maximum line rate).

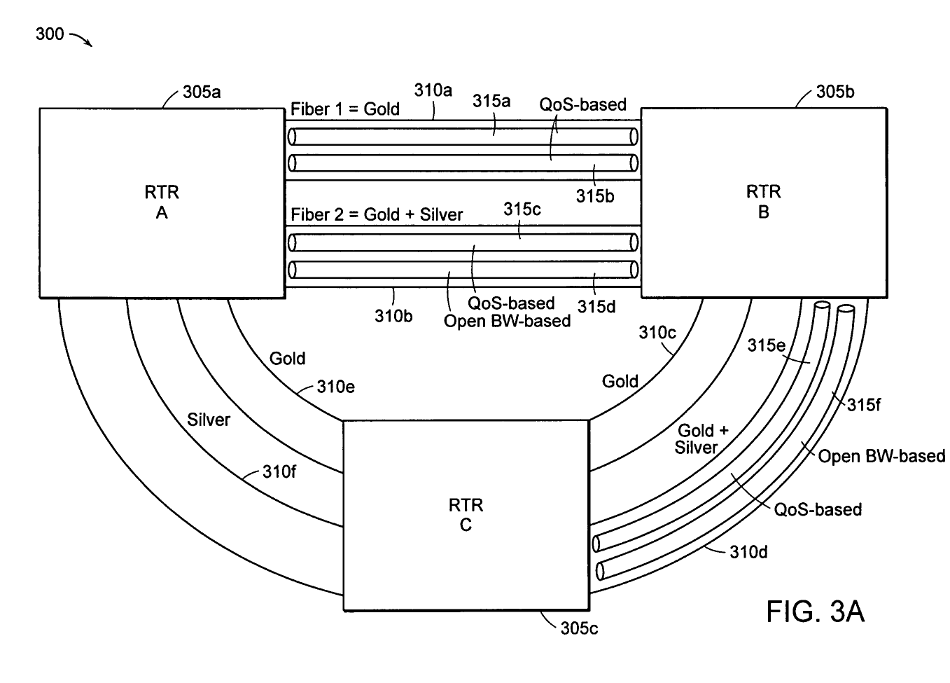

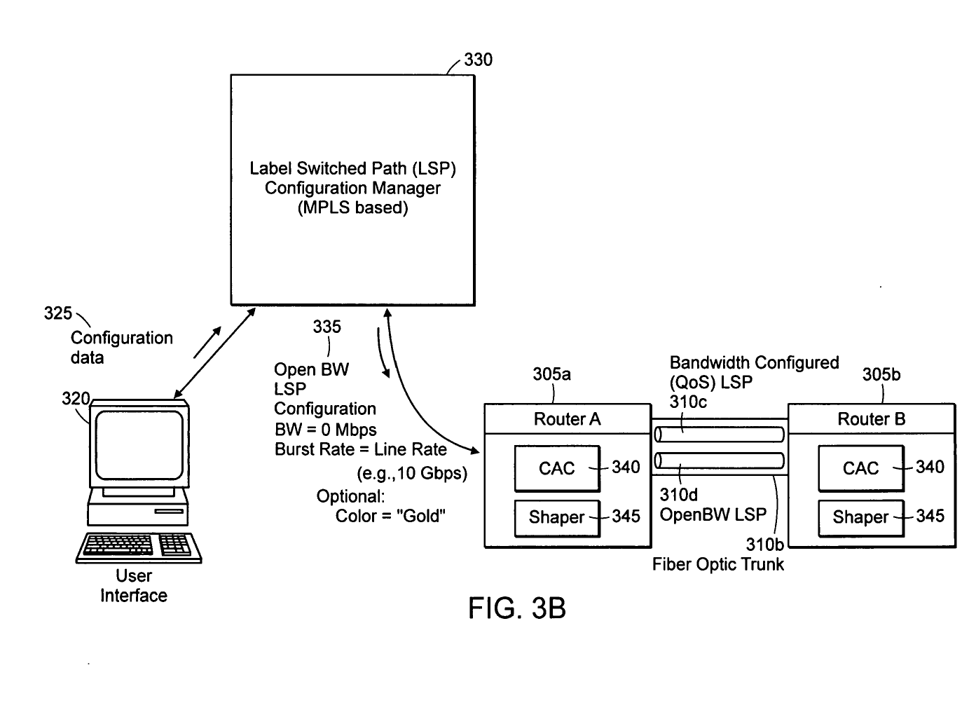

FIG. 3A is a network diagram of an example network illustrating details of an embodiment of the present invention. In this network 300, there are three network nodes: router A 305a, router B 305b, and router C 305c. Routers A and B are provisioned to support LSPs 315a and 315b on a first fiber 310a and a second fiber 310b, where each of the LSPs 315a, 315b is defined as a QoS LSP. Routers A and B on each side of the second fiber 310b are provisioned to support a QoS LSP 315c and an openBW LSP 315d, in accordance with an embodiment of the present invention. Between routers A 305a and router C 305c are optical fibers 310e and 310f, where the routers 305a, 305c are provisioned to support LSPs of the same type or mixed types on each side of the optical fibers 310e, 310f. Between routers B 305b and router C 305c are a first optical fiber 310c and a second optical fiber 310d. As illustrated with respect to the second optical fiber 310d, the routers 305c, 305b on each side of the second optical fiber 310d are provisioned to support a QoS LSP 315e and an openBW LSP 315f.

In this example network 300, colors may be assigned to the optical fibers. For example, the optical fiber 310a and 310b connected between router A 305a and router B 305b are assigned “gold” and “silver” colors, where the first optical fiber 310a is defined as being “gold” in color and the second optical fiber 310b is defined as being “gold and silver.” In this example, a “gold” fiber may be a fiber designated as available to support QoS LSPs (e.g., LSPs 315a, 315b, and 315c). A fiber designated as “silver” may be specified as being available to support openBW LSPs (e.g., LSP 315d). Similarly, one of the optical fibers 310d connecting router B 305b and router C 305c is also defined as a “gold and silver” optical fiber that can support a mixture of QoS LSPs and openBW LSPs.

According to an embodiment of the present invention, the mixed configuration can allow a combination of QoS (i.e., bandwidth configured) and non-QoS (i.e., openBW) LSPs with guaranteed and non-guaranteed data rates, respectively. Any combination of colors, such as 16 colors, 32 colors, and so forth, can be supported according to embodiments of the present invention. Moreover, a service provider can define the colors associated with (i) the LSPs traversing the fiber links and (ii) circuits riding on the LSPs. It should be understood that the colors used in the example network 300 can be defined according to a Request for Comments (RFCs) (e.g., RFC 2697, 2698, or 2859), a standard relating to colors for LSPs, or custom color coding protocol associated with a network.

In one embodiment, a management program can be employed to specify “include” colors and “exclude” colors at the trunk level or LSP level. For example, colors can be associated with trunks, and a management program can allow LSPs to traverse the trunk using a rules-based engine or other technique used to assign or prohibit LSPs to or from trunks, respectively. For example, if a trunk is defined as a “gold” trunk and an LSP is signaled for provisioning on the trunk, the management program may check to see whether the LSP is also “gold” and assign the LSP to the trunk, or prohibit the LSP from being assigned to the trunk, accordingly. In another example, a “gold” trunk can be allowed to carry gold or silver LSPs by the management program. In that same or in another embodiment, a “silver” trunk can be allowed to carry silver LSPs but not gold LSPs. In yet other embodiments, a management program may allow gold and silver LSPs to traverse a gold trunk, gold and silver LSPs to traverse a gold and silver trunk, but prohibit green, red, orange, or other color LSPs from traversing either gold or gold and silver trunks.

Similarly, LSPs can be provisioned to include or exclude circuits that are carried by the LSPs. For example, in one embodiment, a “gold” LSP may be allowed to support “gold” circuits or “silver” circuits, but a silver LSP may be prohibited from carrying gold circuits. Because of the mixed provisioning, it should be understood that trunks can carry multiple colors of LSPs, and, thus, carry multiple types of circuits for a variety of service plans for which a user of the network has contracted with the service provider.

“Martini circuits” are defined as a way of transporting Layer 2 Protocol Data Units (PDUs) (i.e., traffic) across an LSP. Martini circuits may have colors associated with them. When provisioning Martini circuits, the supporting network software can give a user an option to:
(i) prefer QoS circuits, where the circuits are CAC'ed against the LSP;
(ii) prefer an openBW circuit, where the circuits are effectively not CAC'ed against the LSP;
(iii) prefer a traffic engineered LSP;
(iv) prefer Label Distribution Protocol (LDP) LSPs, which signal LSPs in different ways,
(v) and so forth, optionally in that order of priority.

It should be understood that the service provider or, optionally, a customer of the service provider, can provision trunks and LSPs to be specified colors and also specify the color constraints (i.e., determine which trunks an LSP can traverse). The service provider or customer may also be allowed to specify circuits assigned to an LSP, which allows specification of color constraints to determine on which LSP colors a circuit can ride. For example, an LSP with a selected color can traverse a gold trunk, traverse a silver trunk, traverse a gold but not silver trunk, and so forth, according to embodiments of the present invention. In one commercial embodiment, a network carrier may build an MPLS network and lease it to an Internet Service Provider (ISP) or corporate customer. The ISP or corporate customer may lease the MPLS network, or portions thereof, to a corporate customer or individual, respectively. Through use of embodiments of the present invention, the network carrier, ISP, or corporate entity may be allowed to offer QoS or openBW services in the same MPLS network, in contrast to the existing systems which do not allow for offering the combination of QoS or openBW services in the same MPLS network.

FIG. 3B is a network diagram of aspects of the present invention. A user interface 320 in the form of a computer terminal may be employed to enable a user to enter configuration data 325 to configure LSPs. The configuration data 325 is conveyed to an LSP configuration manager 330, which may be MPLS based. The LSP configuration manager 330 may be located on the same computer as the user interface 320, a remote server (not shown), or a router, such as router A 305a.

The LSP configuration manager 330 converts the configuration data 325 to be in a form understandable by the routers 305a, 305b. The LSP configuration manager 330 transmits appropriately formatted configuration data 335 to the routers 305a, 305b in this embodiment. As illustrated, the configuration data 335 includes a bandwidth of zero Mbps and a burst rate equal to a line rate of the fiber optic trunk 310b. Optionally, the configuration data 335 includes a color, such as gold, associated with the openBW LSP configuration data 335.

As described above in reference to at least FIG. 2, a CAC 340 determines whether the openBW LPS can be built based on the bandwidth data, which it will since the bandwidth data is set to zero Mbps, and a shaper 345 is essentially disabled because the burst rate is set equal to the line rate of the fiber optic trunk 310b. The LSP configuration manager 330 may also be equipped to support configuration for bandwidth configured/QoS LSPs. Responsive to the configuration data, LSPs are configured on the fiber optic trunk 310b between router A 305a and router B 305b.

It should be understood that the user interface 320 can be any type of human-machine interface, such as a graphical user interface on a desktop computer. The LSP configuration manager 330 may be integrated with the user interface 320 or be a separate entity, such as a separate application, applet, or other manifestation of computer executable instructions.

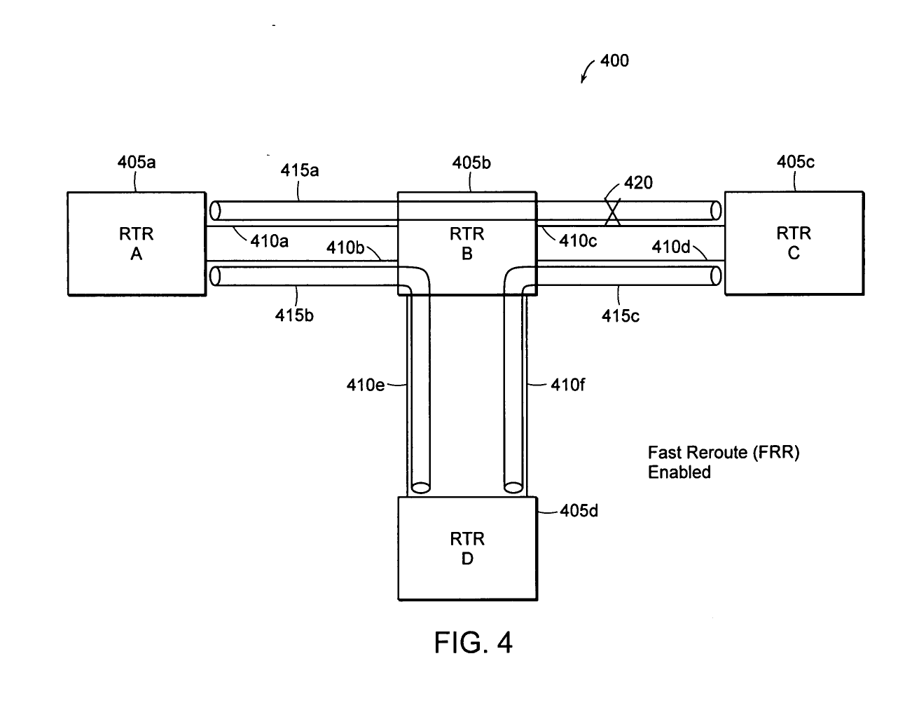

FIG. 4 is a network diagram of an example network 400 having four routers: router A 405a, router B 405b, router C 405c, and router D 405d. This embodiment illustrates an example in which a Fast ReRoute (FRR) is enabled based on use of an embodiment of the present invention. In the example network 400, a first path, which includes optical fiber 410a and optical fiber 410c between router A 405a and router C 405c via router B 405b, has an LSP 415a traversing it. A second optical path between router A 405a and router C 405c is provisioned via four fiber links 410b, 410e, 410f, 410d, including router B 405b and router D 405d. In this configuration, the first LSP 415b traverses first and second fiber links 410b, 410e, spanning from router A to router D via router B, and a second LSP 415c traverses a third fiber link 410f and a fourth fiber link 410d via router B 405b.

Because of a mixed mode capability for supporting LSPs of different types on a single network link according to embodiments of the present invention, the second LSP 415b and third LSP 415c can be provisioned to support both QoS and openBW LSPs. This means that, in an event of a disruption in the first LSP 420, the second and third LSPs 415b, 415c can provide MPLS service between routers A and C via routers B and D. In other words, a Fast ReRoute (FRR) path can be activated in a 50 millisecond (or less) time window for virtually any type of LSP, optionally according to color or service type, because the LSPs 415b, 415c can support the mixed modes. In other words, special LSPs for every type of service agreement or color need not be provisioned because a mixed LSP service agreement can be supported according to embodiments of the present invention.

It should be understood that the fast reroute configuration as illustrated above is exemplary and other configurations, including other nodes, other routes between routers A and C, or other configurations understood in the art, can be provided to support the fast reroute capability in the example network 400.

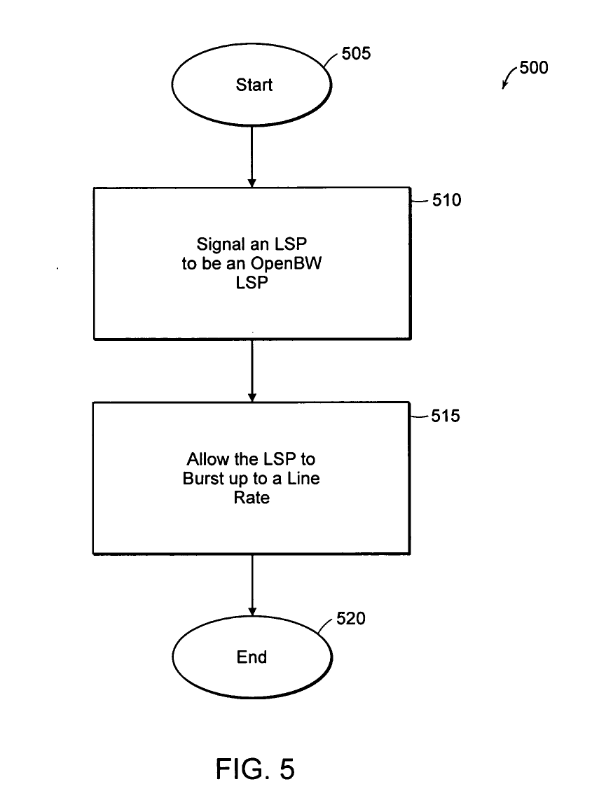

FIG. 5 is a flow diagram of a process 500 that may be employed in the example networks described above. The process 500 starts (505) and signals an LSP to be an openBW LSP (510). The process 500 also allows the LSP to burst up to a line rate (515). The process 500 ends (520), and the LSP is available to carry traffic in bursts up to the line rate of the fiber on which the LSP rides.

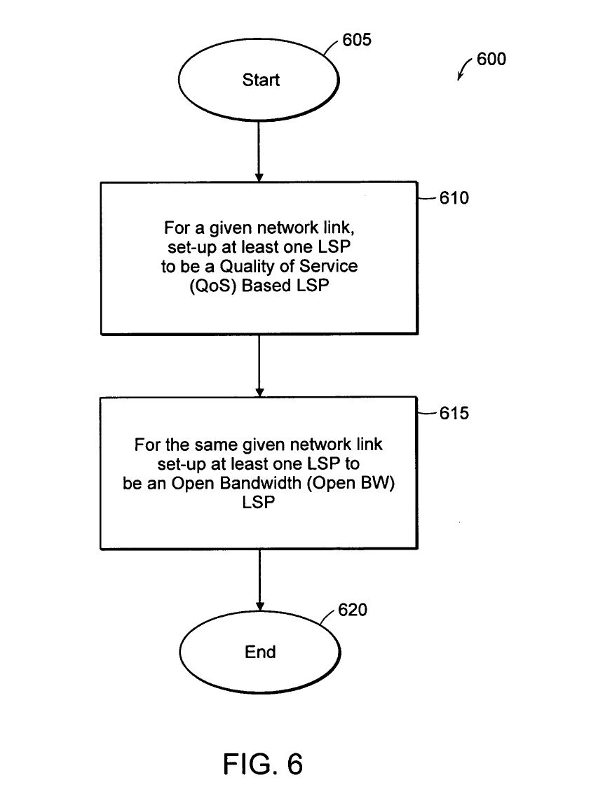

FIG. 6 is a flow diagram of process 600 according to another embodiment of the present invention. The process 600 starts (605) and, for a given network link, sets-up at least one LSP to be a QoS LSP (610). For the same given network link, the process 600 sets-up at least one LSP to be an openBW LSP (615). The process 600 ends (620) thereafter.

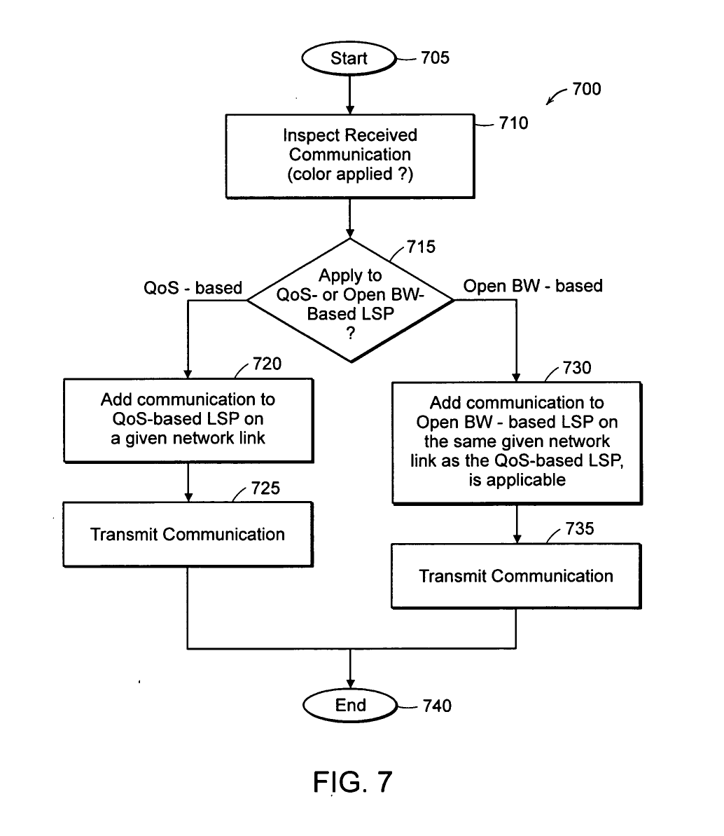

FIG. 7 is a flow diagram of a process 700 according to another embodiment of the present invention. The process 700 starts (705) and inspects received communications (710). In one embodiment, the inspection (710) may include determining whether a color, for example, has been applied to the circuit carrying the communications. A determination is made as to whether the communication applies to QoS or openBW LSPs (715). If the communication is a QoS communication, the communication is added to a QoS LSP on a given network link (720). The communication is then transmitted via the LSP (725) traversing an appropriate network link. If the communication is an openBW communication, the communication is added to an openBW LSP on the same given network link as the QoS LSP, if applicable (730). The communication is then transmitted (735). After communication(s) are transmitted, the process 700 ends (740).

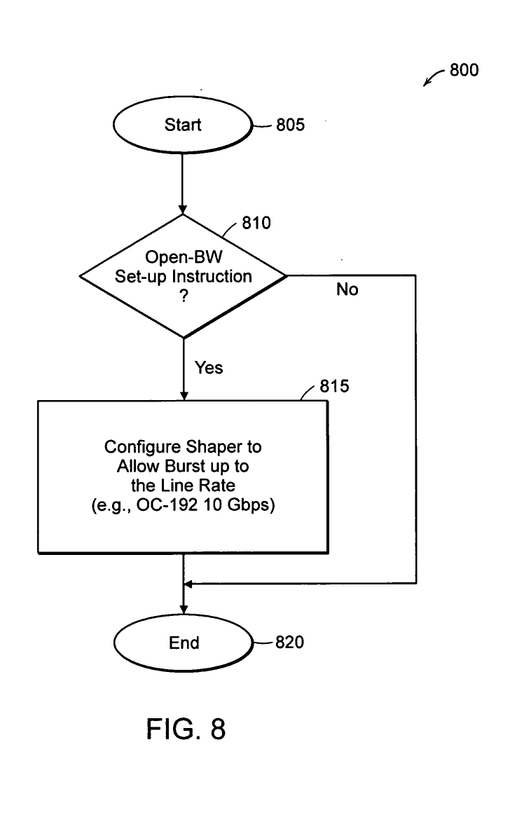

FIG. 8 is a flow diagram of a process 800 operating in a network node that is signaled to provision an LSP in an MPLS environment, for example. The process 800 starts (805) and determines whether an openBW set-up instruction has been received (810). If the openBW set-up instruction has been received, the network node configures its shaper to allow a burst rate up to the line rate (e.g., OC-192, 10 Gbps). The process 800 ends (820) and allows openBW LSPs or a combination of openBW LSPs and QoS LSPs to emanate, terminate, or pass through the given network node. In some embodiments, a CAC inspection may be performed, but, according to embodiments in which the openBW LSPs are signaled with zero data rate, the CAC is guaranteed to pass, so the CAC determination is not illustrated in FIG. 8.

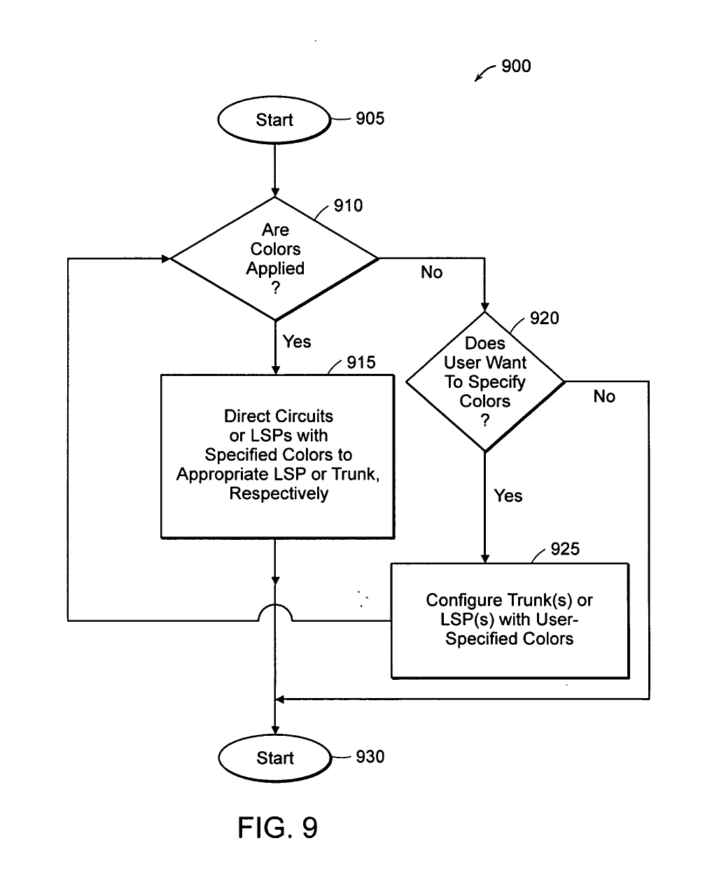

FIG. 9 is a flow diagram of a process 900 that (i) determines if colors are applied to the network links, LSPs, or circuits riding on the LSPs and (ii) allows overlay of the LSPs on the trunks, or circuits on the LSPs, based on the colors or other qualifying indications used for such purposes. The process 900 starts (905) and determines whether colors are applied at any of the aforementioned levels (910). If colors are applied, the circuits or LSPs with specified colors are directed to an appropriate LSP or trunk, respectively. If colors are not applied, then, in this embodiment, a determination may be made as to whether the user wants to specify a color or colors to be associated with an LSP or trunk (920). If the user wants to specify color(s), the trunks or LSPs may be configured with user-specified colors (925), and the process 900 continues to determine whether colors are applied (910). If the user does not want to specify the colors (920), the process ends (930). Also, if colors are applied (910) and the circuits or LSPs with specified colors are directed to the appropriate LSP or trunk, respectively, the process may also end (930).

It should be understood that, in any of the flow diagrams of FIGS. 5-9, the flow diagrams are example embodiments of the present invention. The ordering of the flow diagrams may be changed in any suitable manner. Some blocks may be applied that are not illustrated in FIGS. 5-9, and other portions of the flow diagrams may be repeated or replaced with other embodiments.

It should also be understood that any portions or all of the flow diagrams may be implemented in hardware, firmware, or software. If implemented in software, the software may be implemented in any form of instructions, stored on any form of computer readable medium, and loaded and executed by a processor. The software instructions may be stored locally on a network node or located at a remote server and downloaded via a computer network, such as a computer network shown in FIGS. 1-4 or otherwise understood in the art.

It should also be understood that there may be other aspects of MPLS network protocols that are not described herein, but may be employed concurrently with or suppressed during operations of the techniques disclosed herein.

While this invention has been particularly shown and described with references to example embodiments thereof, it will be understood by those skilled in the art that various changes in form and details may be made therein without departing from the scope of the invention encompassed by the appended claims.

What is claimed is:

1. A method of provisioning a network, comprising:
signaling a Label Switched Path (LSP) to use zero or substantially small bandwidth; and
provisioning the LSP with an ability to burst up to a line rate of a communications path across which the LSP traverses.

2. The method according to claim 1 further including instructing a shaper in a network node along the communications path to allow the LSP to burst up to the line rate of the communications path.

3. The method according to claim 1 wherein the LSP is an open bandwidth (openBW) LSP, and further including provisioning an LSP on the network to be a bandwidth configured LSP.

4. The method according to claim 3 wherein the bandwidth configured LSP is shaped based on a user specified rate and the openBW LSP is set to the line rate.

5. The method according to claim 1 wherein the LSP is an openBW LSP, and further including enabling a user to create multiple logical overlay networks to allow openBW and bandwidth configured LSPs to coexist in the same physical network.

6. The method according to claim 5 wherein the openBW and bandwidth configured LSPs have color labels associated with them, and wherein enabling the user to create multiple logical overlay networks includes enabling the user to configure the multiple logical overlay networks based on the color labels.

7. The method according to claim 1 further including creating preferences whether circuits ride on bandwidth configured or openBW LSPs.

8. The method according to claim 7 further including applying colors to the LSPs and enforcing service rates associated with the colors by enforcing which LSPs can traverse which trunk based on the applied colors.

9. An apparatus for provisioning a network, comprising:
a user interface that accepts user configuration data for a Label Switched Path (LSP) including configuration data corresponding to an open bandwidth (openBW) LSP defined by zero or substantially small bandwidth and a burst rate up to a line rate of a communications path over which the openBW LSP is to traverse; and
an LSP configuration manager, coupled to the user interface and to network nodes, that configures the network nodes in a manner supporting the openBW LSP.

10. The apparatus according to claim 9 wherein the LSP configuration manager instructs a shaper in the network nodes to allow the LSP to burst up to the line rate of the communications path.

11. The apparatus according to claim 9 wherein the user interface further accepts user configuration data for bandwidth configured LSPs and the LSP configuration manager configures the network nodes to support the openBW LSPs and bandwidth configured LSPs.

12. The apparatus according to claim 11 wherein the bandwidth configured LSPs are based on a rate specified by a user.

13. The apparatus according to claim 9 wherein the LSP configuration manager creates multiple logical overlay networks on the network nodes to allow openBW and bandwidth configured LSPs to coexist in the same physical network.

14. The apparatus according to claim 13 wherein the user interface and LSP configuration manager support color labels associated with openBW and bandwidth configured LSPs and also enable the user to create multiple logical overlay networks based on the color labels.

15. The apparatus according to claim 9 wherein the LSP configuration manager configures the network nodes to have circuits ride on bandwidth configured or openBW LSPs.

16. The apparatus according to claim 15 wherein the LSP configuration manager applies colors to the LSPs and enforces service rates associated with the colors by enforcing which LSPs can traverse which trunk based on the applied colors.

17. A network, comprising:
multiple routers;
trunks interconnecting the multiple routers; and
Label Switched Paths (LSPs) traversing the trunks, a first subset of the LSPs being bandwidth configured LSPs, and a second subset of the LSPs being open bandwidth (openBW) LSPs, provisioned with zero bandwidth or substantially small and an ability to burst up to a line rate of the trunks interconnecting the multiple routers.

18. The network according to claim 9 further including multiple overlay networks defined by colors assigned to the trunks to allow a customer to have bandwidth configured and openBW LSPs to coexist without interfering with each other.

19. The network according to claim 10 wherein the trunks are configured to support bandwidth configured LSPs, openBW LSPs, or a combination of each.

20. The network according to claim 9 wherein the trunks and LSPs are assigned a color based on user configuration, and the routers support constraint-based routing of LSPs based on the colors assigned to the trunks and the LSPs.

21. The network according to claim 9 wherein circuits that ride on LSPs are assigned colors, and wherein the LSPs are configured to include and exclude circuits based on their colors.

22. The network according to claim 13 wherein the circuits are constrained to LSPs based on colors and LSPs are constrained to trunks based on colors.

23. A method of offering network services to customers, the method comprising:
offering bandwidth configured service on a network; and
offering open bandwidth services on the same network.
